(19) United States
(12) Patent Application Publication
(10) Pub. No.: US 2013/0179515 A1
(43) Pub. Date: Jul. 11, 2013

(54) FACILITATING COORDINATED AND COLLABORATIVE AUTHORING USING MESSAGING

(71) Applicants: Chang Yan CHI, Beijing (CN); Eric M. WILCOX, Los Altos, CA (US); Wen Peng XIAO, Beijing (CN); Min YANG, Beijing (CN); Michelle X. ZHOU, Saratoga, CA (US)

(72) Inventors: Chang Yan CHI, Beijing (CN); Eric M. WILCOX, Los Altos, CA (US); Wen Peng XIAO, Beijing (CN); Min YANG, Beijing (CN); Michelle X. ZHOU, Saratoga, CA (US)

(73) Assignee: International Business Machines Corporation, Armonk, NY (US)

(21) Appl. No.: 13/348,249

(22) Filed: Jan. 11, 2012

(51) Int. Cl. G06F 15/16

(52) U.S. Cl. 709/206

(57) ABSTRACT

A first message associated with a collaborative task is received from a user. The first message includes an identification of the collaborative task, a plurality of participants for the collaborative task, and a request from the user for each of the participants to provide content for the collaborative task. In response to receiving the first message, a processor generates a request message for each of the participants. Each of the request messages includes a notification of the collaborative task and the request from the user for that participant to provide the content for the collaborative task. The request messages are sent to the participants.

### BACKGROUND

The present invention generally relates to collaboration tools, and more particularly relates to integrating messaging with collaboration tools.

Various dedicated collaboration tools (e.g., wikis) are used to help individuals organize task materials in single location where all members can view these task materials. Collaboration topics (e.g., a particular wiki) can be created in those tools to work on a particular aspect of the project. For example, a sales team may use a wiki to keep track of the team's sales leads and status, while a group of software developers may use a wiki to post their development schedule and progress.

### BRIEF SUMMARY

In one embodiment, a method is disclosed. The computer-implemented method comprises receiving, from a user, a first message associated with a collaborative task. The first message includes an identification of the collaborative task, a plurality of participants for the collaborative task, and a request from the user for each of the participants to provide content for the collaborative task. In response to receiving the first message, a request message is generated for each of the participants. Each of the request messages includes a notification of the collaborative task and the request from the user for that participant to provide the content for the collaborative task. The request messages are sent to the participants.

In another embodiment, an information processing system is disclosed. The information processing system comprises a memory and a processor that is communicatively coupled to the memory. A messaging manager is communicatively coupled to the memory and the processor. The messaging manager is configured to perform a method comprising receiving, from a user, a first message associated with a collaborative task. The first message includes an identification of the collaborative task, a plurality of participants for the collaborative task, and a request from the user for each of the participants to provide content for the collaborative task. In response to receiving the first message, a request message is generated for each of the participants. Each of the request messages includes a notification of the collaborative task and the request from the user for that participant to provide the content for the collaborative task. The request messages are sent to the participants.

In a further embodiment, a computer program product is disclosed. The computer program product comprises a non-transitory computer readable storage medium having computer readable program code embodied therewith. The computer readable program code is configured to perform a method. The method comprises receiving, from a user, a first message associated with a collaborative task. The first message includes an identification of the collaborative task, a plurality of participants for the collaborative task, and a request from the user for each of the participants to provide content for the collaborative task. In response to receiving the first message, a request message is generated for each of the participants. Each of the request messages includes a notification of the collaborative task and the request from the user for that participant to provide the content for the collaborative task. The request messages are sent to the participants.

As will be discussed in greater detail below, various embodiments of the present invention provide a collaboration environment that supports coordinated, collaborative authoring. One or more embodiments provide a messaging interface for users to accomplish their tasks using messages, such as email, in a coordinated, collaborative authoring process. In one embodiment, a semi-structured, template-based approach is implemented that allows users to use templates to specify their requests in messages. These message requests can be interpreted by the collaboration environment manager and are used to automatically drive the collaboration flow. As part of its actions, the collaboration environment manager automatically creates a collaborative environment page, such as a wiki page, and dynamically updates the page to record co-authoring tasks and collate co-authored content. As a result, users can use a tool with which they are familiar (e.g., a messaging client and messages) to accomplish their tasks in a co-authoring process, while leveraging a wiki for additional benefits (e.g., obtaining collaboration awareness and formatting the text).

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating an operating environment according to one embodiment of the present invention;

FIG. 2 illustrates various transaction flows between users and a collaborative environment according to one embodiment of the present invention;

FIG. 3 illustrates an exemplary email message created using a collaborative environment messaging template according to one embodiment of the present invention;

FIG. 4 illustrates an exemplary collaborative environment page created based on the email message of FIG. 3 according to one embodiment of the present invention;

FIG. 5 illustrates an exemplary notification email message to be sent to a participant identified in the email message of FIG. 3 according to one embodiment of the present invention;

FIG. 6 illustrates an exemplary reply email message created by a participant in response to receiving the notification email message of FIG. 5 according to one embodiment of the present invention;

FIG. 7 illustrates the collaborative environment page of FIG. 4 after updating the page based on the reply email message of FIG. 6 according to one embodiment of the present invention;

FIG. 8 illustrates an exemplary status email message created by a collaborative environment according to one embodiment of the present invention;

FIGS. 9-11 are operational flow diagrams illustrating a process for facilitating coordinated and collaborative authoring using messaging according to one embodiment of the present invention; and

FIG. 12 is a block diagram illustrating a detailed view of an information processing system according to one embodiment of the present invention.

### DETAILED DESCRIPTION

### Operating Environment

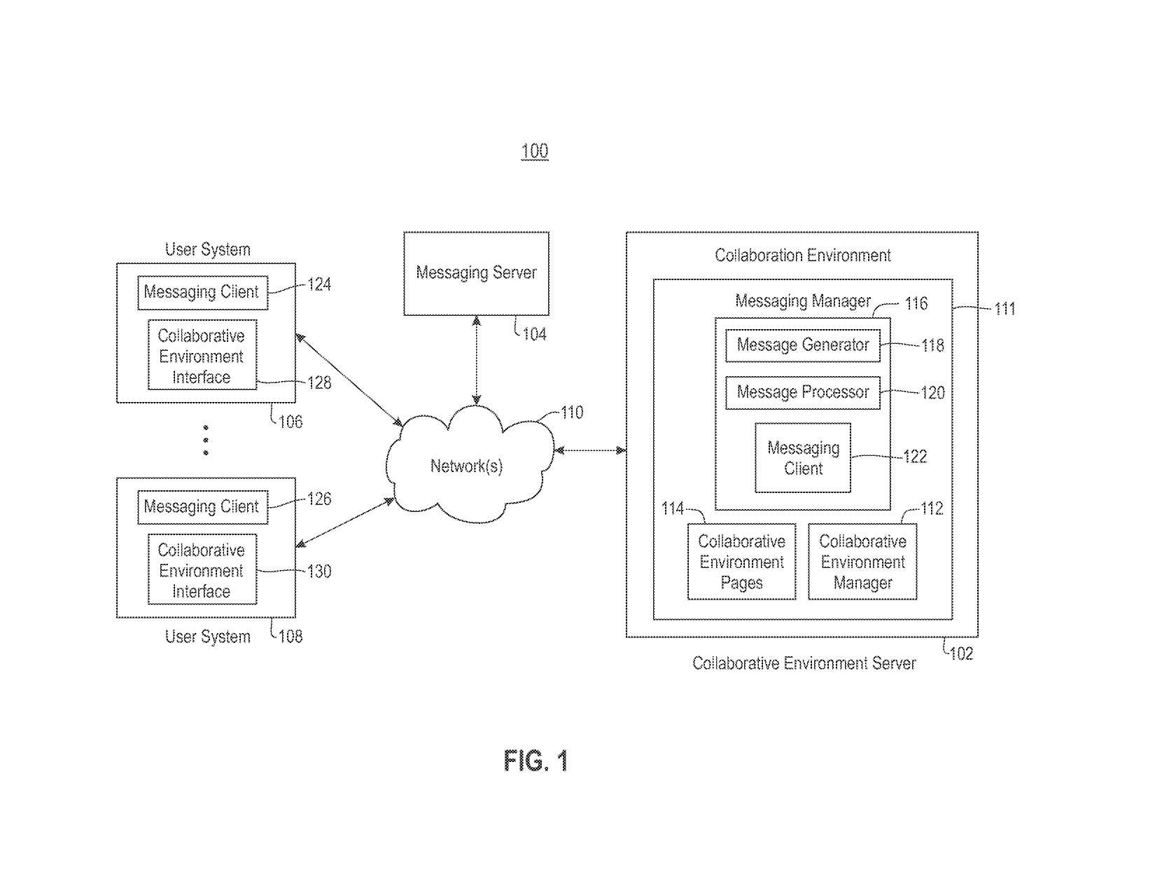

FIG. 1 shows an exemplary operating environment 100 applicable to various embodiments of the present invention. The operating environment includes at least one system for integrating messages, such as emails, with collaboration tools. This integration facilitates coordinated collaborative authoring using messaging and collaboration tools. Although the following discussion uses email as one example of messaging, other types of messaging, such as instant messaging, short-message-service (SMS) messaging, etc., are also applicable.

The operating environment 100 includes one or more server systems 102 and 104, and one or more user systems 106 and 108. Each of these systems is communicatively coupled to one or more networks 110. The network 110, in this embodiment, is a wide area network, local area network, wired network, wireless network, or the like. A collaboration environment server system 102 includes a collaboration environment 111. The collaboration environment 111 includes a collaboration environment manager (coordinator) 112. The collaboration manager 112 creates collaborative environment pages 114, such as wiki pages. The collaboration manager 112 also manages and supports user interactions with the collaboration environment 111. The collaboration environment 111 also includes a messaging module/manager 116. The messaging manager 116 includes a message generator 118 and a message processor 120. The messaging manager 116, in this embodiment, utilizes a messaging client 122 to send and receive messages to/from users of the user systems 106 and 108 via a messaging server 104 (which can be separate from or part of the server system 102). One or more of the collaboration environment components can be combined into a single component, and one or more of these components can reside on one or more other systems as well.

In one embodiment, the collaboration environment 111 utilizes the above components to receive, from a user, a first message associated with a collaborative task. The first message includes at least an identification of the collaborative task, a set of participants for the collaborative task, and a request by the user for each of the participants to provide a set of content for at least one portion of the collaborative task. The collaboration environment 111 automatically generates a second message for each of the participants in response to receiving the first message. The second message includes at least a notification of the collaborative task and the request from the user for the participant to provide the set of content for the portion of the collaborative task. The collaboration environment 111 sends the second message to each of the participants.

FIG. 1 also shows that each user system 106 and 108 includes a messaging client 124 and 126 and a collaboration environment interface 128 and 130. The messaging client 124 and 126 allows the user to send and receive messages to/from other users and the collaboration environment 111 via the messaging server 104. The collaboration environment interface 128 and 130 allows the users to interact with the collaboration environment 111.

### Collaboration Environment

The collaboration environment 111 of this embodiment is a wiki-based tool that supports coordinated, collaborative authoring. A wiki is one example of a collaborative authoring tool. For example, a sales team may use a wiki to keep track of the team's sales leads and status, while a group of software developers may use a wiki to post their development schedule and progress. In a business setting, collaborative authoring often requires coordination, including assigning authors to specific sections and managing their progresses. Conventional wikis, however, do not directly support coordinated, collaborative authoring. In contrast, the collaboration environment 111 of this embodiment utilizes one or more wikis to support a coordinated co-authoring process, which can be across different domains (technical, legal, healthcare, etc.). The collaboration environment 111 of this embodiment uses a tag-based approach to support two key user roles and their respective tasks in such a process.

First, the collaboration environment 111 supports the role of a coordinator or lead author, who can insert tags in a wiki page to specify co-authoring tasks. A coordinator or lead author initiates and manages the overall collaboration process. For example, a sales manager leads a sales team to co-write a sales report; and a project leader organizes project members to co-author project updates. In such cases, a coordinator often performs tasks such as: defining authoring tasks for individual members (i.e., who writes what), managing member progresses (e.g., reminding them of their impending tasks), and writing part of the content.

Second, the collaboration environment 111 supports the role of a participant, who is a co-author invited by a coordinator to write designated sections of a wiki. A co-author can be invited by a coordinator to write designated sections of a document. One of the participant's tasks is to handle the received writing assignments in one of the following ways: accept a request to write the specified sections, reject the request, and delegate the entire or part of the request to one or more other individuals. To support flexible user roles in a dynamic collaborative authoring process, the collaboration environment 111 allows a participant to initiate authoring tasks in the same workflow (e.g., adding new sections). In this embodiment, the participant plays the role of a local coordinator who manages and initiates authoring tasks.

In this embodiment, the collaboration environment 111 supports the above user roles and associated tasks by helping users better manage a collaborative authoring process (e.g., defining and monitoring co-authoring tasks) to minimize interruptions on their own content writing. The collaboration environment 111 also helps increase users' awareness of each other's activities and status for a more transparent and efficient collaboration. To minimize interruptions, the collaboration environment 111 lets a user performs all tasks in the main workspace. In this embodiment, the main workspace is a wiki page where the content is being created, edited, and viewed.

To support all tasks of a user in a wiki, the collaboration environment 111 implements a tag-based approach to document authoring. In this embodiment, tags are directly attached to the content inside a wiki page to indicate related activities and status. Tags can also be executed to drive a collaboration flow (e.g., inviting a participant). Tags that specify co-authoring tasks are referred to as task tags. In this embodiment, tag usage is implemented as an integral feature of a wiki, and the collaboration environment 111 supports tag editing (add, remove, and modify) in a wiki edit mode. This design makes tag editing a natural part of the content editing, minimizing the interruptions on a user's primary task of content writing. This feature also allows users to define authoring assignments while they are writing or editing specific portions of a document.

In this embodiment, the task tags have simple and unambiguous semantics. This allows tags to be easily defined and understood by intended recipients (e.g., users and the collaboration environment 111). In this embodiment, the collaboration environment 11 is configured to extract task parameters (e.g., author name and due time) to drive the collaboration process (e.g., notifying participants about their tasks). Therefore, in this embodiment, a tag widget with structured fields is utilized as compared to a plain text-based tag. Task tags provide collaboration awareness for all the co-authors since the tags already include information about collaborators' activities and status. Task tags can be dynamically updated and visually encoded to reflect the evolving task status.

In this embodiment, a task tag has various fields that describe key aspects of a collaborative writing process. A first set of fields can be user-defined fields such as a participants field, a due date/time field, and a task description field. A second set of fields includes a status field and a log field (logging the task delegation path). This second set of fields is reserved for the collaboration environment 111 to track and update a collaboration flow. Additional fields can be utilized as well. In one embodiment, a user can toggle among various display modes of a task tag: full, summary, and iconic view. Additional visual cues (e.g., dotted versus solid sideline) can be used to differentiate the tag content from the document content. For example, arrow direction can be used to indicate the task flow related to the current user.

To support the role of a coordinator, the collaboration environment 111 allows a user to: Add a Task (creating a task tag to assign participants to a specific section), Send a Task (triggering the collaboration environment 111 to email task recipients), and Remind (triggering the collaboration environment 111 to send an email reminder to designated participants). Once a tag is added, only the tag creator can edit its fields. However, in other embodiments, other users can edit the fields of a tag. A valid authoring task specifies one or more participants. The collaboration environment 111 allows users to specify participants' names or email addresses. The collaboration environment 111 maps names to email addresses before emailing designated participants about their tasks upon a Send Task request. On the server side, an event-driven finite state machine is implemented to handle various user requests (e.g., Remind) and drive the collaboration flow (e.g., email reminders to designated participants). In one embodiment reminders are automatically sent by the collaboration environment 111. In another embodiment, the collaboration environment 111 does not send users automatic reminders for overdue tasks. This embodiment provides users with one or more options to take actions and avoid adverse consequences (e.g., flooding the inbox of an out-of-office user).

Upon receiving the email notification of a collaborative task (e.g., a writing assignment), a participant can follow a uniform resource locator (URL) link embedded in the email to open the wiki page. The participant is directed to enter content in the designated area for the task tag. The participant can also reject or transfer the task by clicking on a corresponding widget or entering a corresponding response. When a task is transferred, the collaboration environment 111 automatically updates the participant field of the transferred task with new participants. The corresponding log field is also updated to indicate the transfer path. This information is useful for users to keep track of re-routed tasks. Once a participant has completed the work, it can be submitted. Once the work is submitted, it is available for the coordinator and other co-authors to view. In one embodiment, users cannot view other user's writing prior to its submission. However, this is not a required feature.

The user-inserted tags can be executed by the collaboration environment 111 to automatically drive the collaboration workflow (e.g., notifying co-authors about their tasks), and provide collaboration awareness for all the collaborators (e.g., showing the co-authoring task status in the wiki). Therefore, the collaboration environment 111 extends wikis in at least two aspects. First, wikis are extended to support tag-based collaboration management with little interruption on a user's primary task of content authoring. Second, wikis are extended to support content-centric collaboration awareness (e.g., aware of co-authors' work and status). In one embodiment, the collaboration environment 111 also preserves standard wiki features. For example, coordinators can enter and modify content anywhere in a wiki page. Similarly, participants can enter content in their designated space or any unrestricted areas of the page. In this embodiment, participants can only view but not modify other users' work unless they are invited to do so. However, this is not a required feature.

The collaboration environment 111, in this embodiment, utilizes messaging, such as email, to facilitate coordinated, collaborative authoring. In particular, the collaboration environment 111 employs a semi-structured, template-based approach, which allows users to use templates to specify their requests in emails and the emailed requests can be interpreted by the collaboration environment 111 to automatically drive the collaboration flow (e.g., notifying co-authors about their tasks or extracting a co-author's response from an email). As a result, users can complete their co-authoring tasks by email and the collaboration environment 111 with much less manual effort (e.g., monitoring the progress and collating multiple responses). Furthermore, users can leverage the collaboration environment 111 created page/wiki 114 to access the co-authored content and perform additional tasks (e.g., content formatting). As a shared work space, the wiki 114 also provides all collaborators with the desired collaboration awareness.

### Coordinated Collaborative Authoring Using Messaging

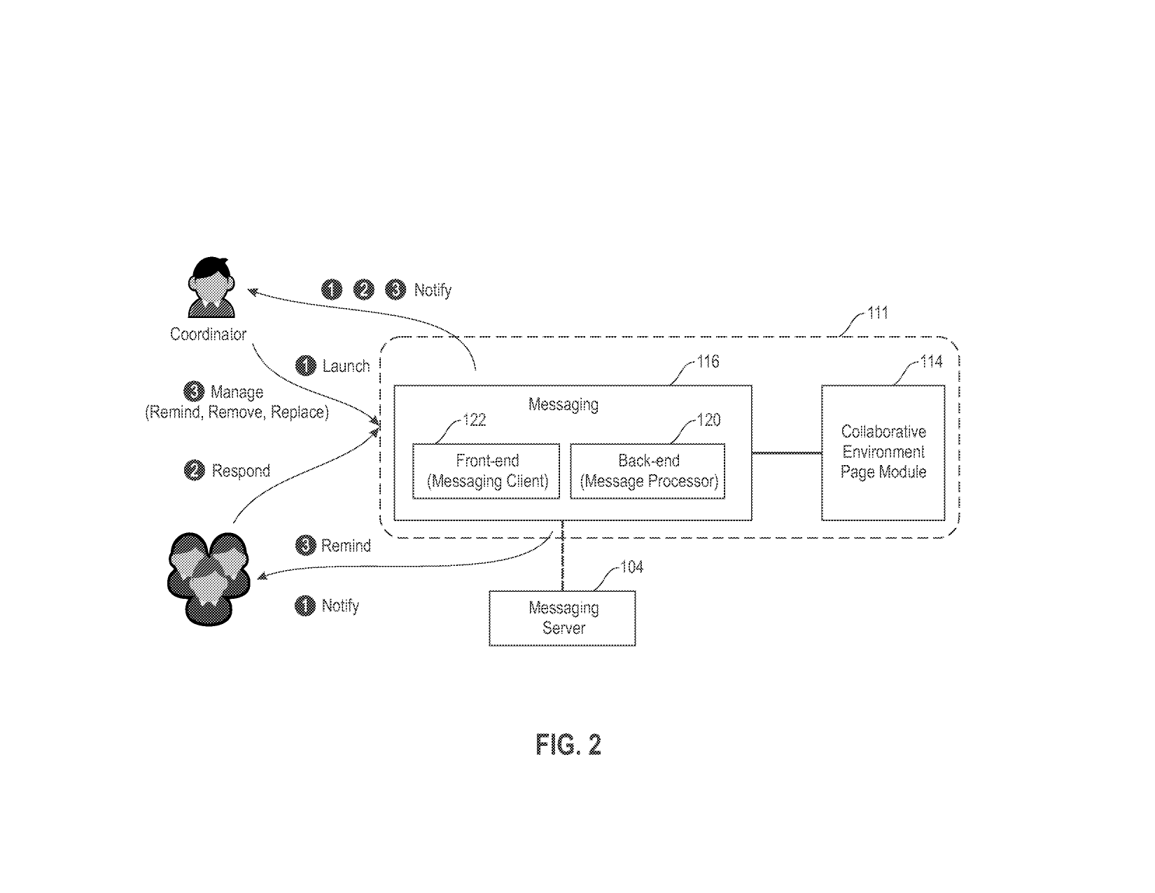

As discussed above, the collaboration environment 111 is configured to support the tasks of both coordinators and participants in a coordinated, collaborative authoring process. Users are able to perform their tasks by messaging mechanisms such as email. As shown in FIG. 2, the collaboration environment 111 includes at least two modules: a messaging manager/module 116 and a collaborative environment page module 114 (also referred to as a “wiki module” or “wiki”). The messaging module 116, in this embodiment, is built on top of an existing messaging system, such as an email system, to support messaging interaction between a user and the collaboration environment 111. The messaging module 116 includes a front-end component 122 that allows a user to compose a collaboration environment-understood email, and a back-end component 120 that processes a user's messages. The wiki module 114 supports user interactions with a wiki. In this embodiment, the wiki module 114 is an extension on top of a regular wiki to support a coordinated, co-authoring process.

FIG. 2 also shows various interactions supported by the collaboration environment 111 for a coordinated, collaborative authoring process utilizing a messaging mechanism such as email. For example, FIG. 2 shows that the collaboration environment 111 supports: (1) launching a collaborative authoring process, (2) responding to a co-authoring task, and (3) managing the co-authoring process. Other interactions, such as when a coordinator writes/edits part of content, can also be supported by the collaboration environment 111.

FIG. 2 shows that a coordinator launches a collaborative authoring process by creating and sending an email message to the collaboration environment 111 utilizing the messaging client 124 on the user system 106. This email message is addressed to the collaboration environment 111 using an email address associated therewith and also defines a set of co-authoring tasks for a collaboration project. The messaging manager 116 receives the email message, which is analyzed/processed by the message processor 120. Based on this analysis the collaboration environment manager 112 identifies the set of co-authoring tasks within the message and each co-author associated with each of the co-authoring tasks. The collaboration environment manager 112 then creates a collaborative environment page (wiki page) 114 associated with the collaboration project. The message generator 118 of the collaboration environment 111 generates and sends an email message, via the messaging client 122, to each of the identified co-authors. This email message notifies the co-authors about their respective tasks.

A participant (co-author) can respond to the assigned co-authoring task by messaging, such as email. For example, the participant can reply to the message received from the collaboration environment 111 indicating that the participant accepts, declines, or transfers the assignment. The participant can also generate a new message and is not limited to replying to the message received from the collaboration environment 111. The user can type a response to the co-author assignment directly into the email. In another embodiment, a list of response choices (e.g., accept, reject/decline, transfer, etc.) is presented to the participant within the email. The user is then able to select one of these choices for responding to the co-authoring request.

In some situations a group of people may be required to co-author interdependent content. For example, consider a coordinator who is setting up a visitor's agenda. The coordinator lists the visitor's available time slots and then asks her colleagues to enter their proposed topics and preferred time slots to meet with the visitor. Because two people cannot occupy the same slot, one person's decision depends on the others' decisions. In this example, the collaboration environment 111 gathers user inputs from emails and posts them to the wiki page 114, and then lets the coordinator organize them manually. Alternatively, users can view others' input in the wiki 114 and then decide on their own. In another embodiment, the collaboration environment 111 can be configured to automatically manage scheduling information and conflicting schedules.

Once the participant has completed the reply email message, the message is sent to the collaboration environment 111. The collaboration environment 111 then receives the message from the participant. The message processor 120 extracts the submitted content from the response/reply email received from the participant. For example, the participant's acceptance of the co-author assignment can be extracted. The collaboration environment manager 112 then updates the corresponding wiki page 114 with the extracted information. If the participant decides to reject or transfer the task, the collaboration environment 111 forwards such responses to the coordinator for review. The coordinator can also manage the collaborative authoring process by sending email messages to the collaboration environment 111. For example, the coordinator can specify various management actions, including reminding and removing a co-author. Per the coordinator's email request, the collaboration environment 111 can then act upon on the coordinator's behalf. In one embodiment, the collaboration environment 111 sends email notifications to the coordinator for updating the coordinator regarding the status of the collaboration project and interactions with the co-authors (e.g., being aware of co-authoring tasks assigned or reminders sent). This is shown in FIG. 2 by the “Notify” flow from the collaboration environment 111 to the coordinator.

As discussed above, the messages (e.g., emails) sent by the users to the collaboration environment 111 are created in a format that can be parsed by the collaboration environment 111. This allows the collaboration environment 111 to understand a user's email message (e.g., specifying co-authoring tasks) and act upon it (e.g., creating a wiki page and notifying co-authors). Therefore, in this embodiment, the collaboration environment 111 supports a semi-structured email input. This provides a set of semi-structured messaging templates for users to specify their intended tasks. Following these templates, the collaboration environment 111 can interpret a user's email message and use it to drive the collaboration authoring process.

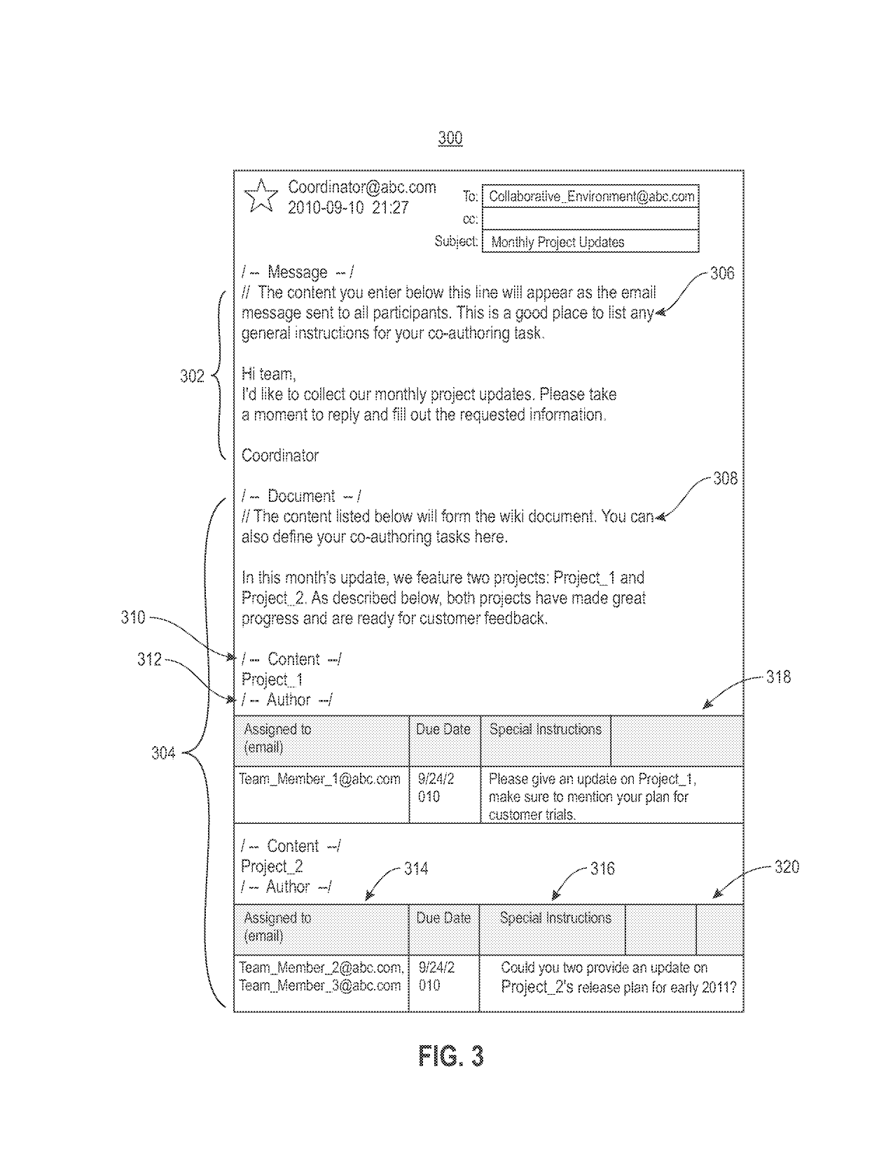

The following is a more detailed discussion of such messaging templates. A coordinator can launch a collaborative authoring project by defining a set of co-authoring assignments, as discussed above. In one embodiment, the coordinator launches a collaborative authoring process by generating a message, such as an email message, that includes co-authoring information. For example, the coordinate utilizes a messaging client 128 to generate an email message using a collaboration environment messaging template that captures at least the key elements of a co-authoring assignment. FIG. 3 shows an exemplary email message that includes co-authoring information created by a coordinator using a messaging template. The messaging template can be automatically loaded when the user creates a new message or can be loaded after a user creates a new message to automatically format the message according to the messaging template. These messaging templates can be stored locally on the user system 106 and/or received from the collaboration environment 111.

FIG. 3 shows an email message 300 having multiple sections 302 and 304. A first section 302 comprises a message directed to one or more co-authors. A second section comprises a filled-in template that defines a set of co-authoring tasks. Each section can include optional comments 306 and 308 that describe the type of content to be added to each section 302 and 304. In general, defining a co-authoring task includes at least one or more of the following elements: content 310, author 312, due time 314, and instructions 316.

The content field 310 comprises the information (content) to be authored by a designated participant. For example, FIG. 3 shows that the coordinator has indicated that Team_Member_{—}1 is to author “Project 1” content. In some cases, the coordinator may provide part of the content within the content field 310. For example, FIG. 3 shows that the coordinator has included the content “Project 1” and “Project 2”. Moreover, the content field 310 may specify multiple items to be authored. For example, when composing an employee assessment report a coordinator can ask the co-authors to supply multiple pieces of data, including employee name, band level, and performance rating.

The author field 312 comprises an identifier (e.g., email address) that can be used to uniquely identify a co-author. The due date/time field 314 specifies the due time of the task. The instructions field 316 records the coordinator's instructions to the co-author with respect to the task assigned to the co-author. In practice, users may also use different combinations of such elements to define different types of co-authoring tasks. For example, FIG. 3 shows that Coordinator defines two co-authoring tasks 318 and 320. The first task 318 (“Project 1”) has one author assigned, while the second task 320 (“Project 2”) has two authors assigned.

A few examples of co-authoring tasks are:

Type 1: [Content, Author, dueTime, Instruction]

Type 2: [Content, [<Author>+, dueTime, Instruction]+]

Here, Type 1 specifies one author per task, while Type 2 defines multiple authors per task with or without the same due times or instructions. Because Type 1 can be considered a special case of Type 2, Type 2 can be further generalized to define multiple co-authoring tasks:

[Content, [<Author>+, dueTime, Instruction]+]+ (1)

Formula 1 is a very general template and can be used to capture all co-authoring tasks.

As represented by Formula 1, the information captured by this template can be potentially quite complex, including multiple co-authoring tasks with different compositions of the elements. To help users fill in this template and help the collaboration environment 111 process with the filled-in information, a combination of tables and text blocks can be used to represent the content of the template. In this embodiment, tables are used to encode simple and deterministic information, while complex content is placed in text blocks. As shown in FIG. 3, the content to be authored is in a text block and the author related information is represented in a table. Here, the tabular form allows the collaboration environment 111 to easily process and extract the needed content, while the text block is natural for a user to follow the text flow. Alternatively, a table or text blocks can be used to represent the entire template.

In addition to launching a collaborative authoring process, a coordinator can also monitor and manage the overall co-authoring process. In one embodiment, the collaboration environment 111 also supports management actions by email. A few examples of management actions are reminding co-authors of their tasks, removing a co-author, and replacing a co-author with a new one.

Each management action can be associated with a separate template such as:

Remind: [timer, <targetAuthor>+, message]+ (2)

Remove: <targetAuthor>+ (3)

Replace: [<originalAuthor>, <targetAuthor>]+ (4)

As shown in Formula 2, the Remind template has three basic elements: timer, targetAuthor, and message. Here the timer defines when the reminder should be sent to one or more target authors. In this embodiment, the target authors are those who have not finished their assigned tasks when the timer expires. The Remove template takes as input one or more target authors to be deleted (Formula 3). The last template, Replace, takes as input the specification of the original co-author and a new one (Formula 4). A separate template is not required for Add (adding a co-author or a co-authoring task), which is part of defining a co-authoring task.

In this embodiment, the coordinator is able to utilize a management template when two conditions have been satisfied. First, a collaborative authoring process should exist (already be launched), otherwise there is nothing to manage. Second, the coordinator should be able to indicate which collaborative authoring process to manage. To satisfy the first condition, the collaboration environment 111 does not make management templates available to users if no co-authoring tasks exist. To help meet the second condition, the collaboration environment 111 lists all ongoing collaborative authoring projects in a menu from which a coordinator can select one to manage. After selecting a co-authoring project, the coordinator can then use an action template to specify management needs in an email.

Upon a coordinator's management request (e.g., sending a reminder to participants), the collaboration environment 111 acts on the coordinator's behalf. For example, the collaboration environment 111 imitates sending a reminder as if it were done by a person in a collaboration environment wiki 114. However, an extra step is performed to provide the desired awareness, which is otherwise missing in a normal email interaction. For example, for all three actions (Remind, Remove and Replace), the collaboration environment 111 emails the coordinator a confirmation with a status report after it performs the action per the coordinator's request.

As can be seen, the messaging templates discussed above allow a coordinator to easily specify a set of co-authoring tasks and/or management actions in an email message. In some instances users may make mistakes when filling in such templates (e.g., entering an invalid email address for a co-author). Correcting these mistakes after the email message is sent would require additional email interactions between the user and the collaboration environment 111. Therefore, a coordinator can interactively validate an email message before sending it to the collaboration environment 111 so that user mistakes can be caught and rectified before an unwanted or erroneous email is sent. In one embodiment, validating an email message is performed by checking the validity of each field (e.g., email IDs and a valid due time).

The format of the messaging templates discussed above allows the messaging manager 116 of the collaboration environment 111 to easily parse the email messages received from users. For example, the template formats allow the message processor 120 to extract co-authoring tasks from the message. Using the extracted information, the collaboration environment 111 performs one or more operations. For example, the collaboration environment manager 112 can create a collaboration environment wiki page 114 that includes the content that the coordinator has authored and the content to be co-authored extracted from the message received from the coordinator. The collaboration environment manager 112 can also use extracted information to insert a set of task tags (e.g., co-authors, due time, and task status) in the wiki page 114. These task tags not only are useful for driving the collaboration flow but also provide collaboration awareness.

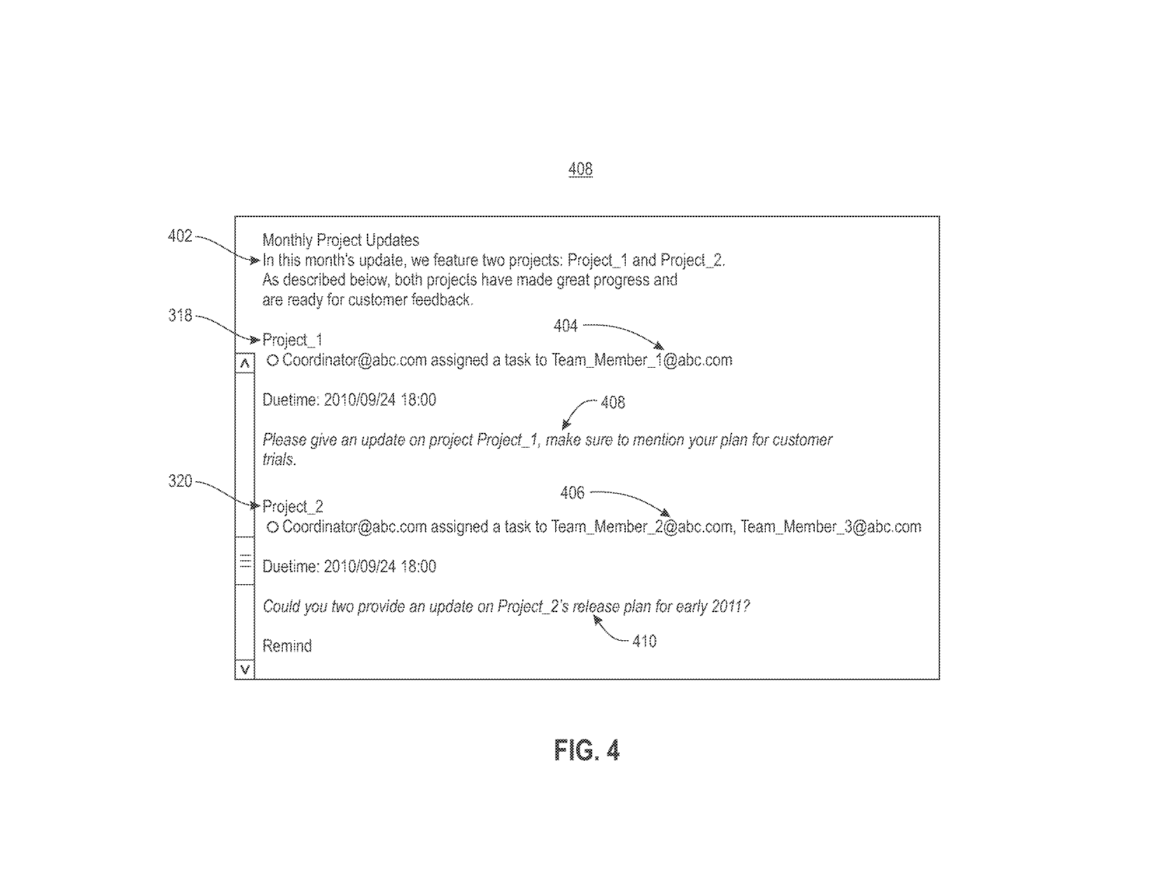

FIG. 4 shows an exemplary wiki page 400 created by the collaboration environment manager 112 based on the information in the email message shown in FIG. 3. As can be seen, the wiki page 400 includes a message 402 from the coordinator from the first section 302 of the email message 300, the task, such as the content 318 and 320, to be performed/authored by a co-author, the co-author 404 and 406 designated to author the specified content, the due date/time, and any instructions 408 and 410 from the coordinator to the co-author.

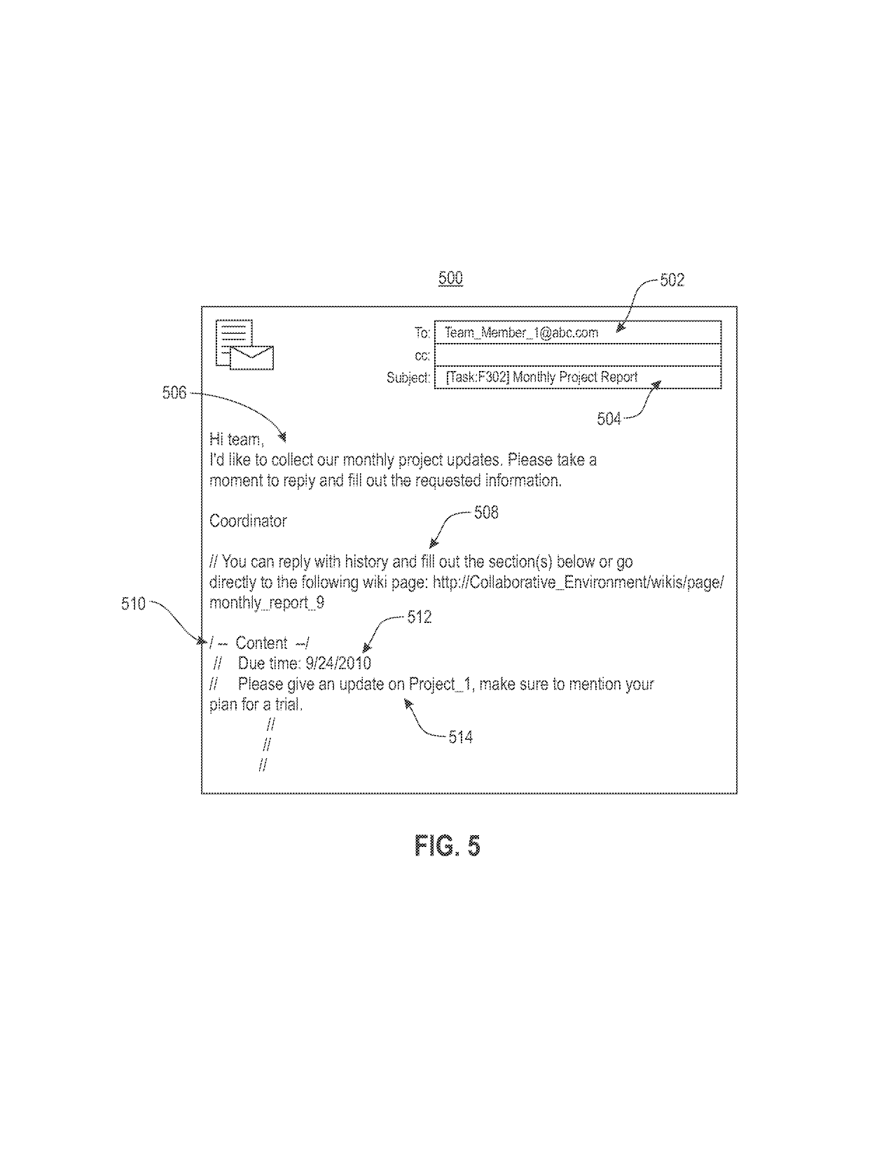

The collaboration environment 111 also notifies each user that the coordinator has requested their participation in the collaboration project as a co-author. For example, based on the identifier of each requested co-author extracted from the coordinator's message, the message generator 118 creates a message, such as an email message, to be sent to each of these co-authors. This email message includes, or is formatted according to, the messaging template discussed above. For example, FIG. 5 shows an exemplary email message 500 generated by the message generator 118 and sent to one of the co-authors, Team_Member_{—}1. The email message includes an address field 502 comprising a messaging address of the co-author (e.g., Team_Member_{—}1@abc.com) and a subject field 504 that identifies the subject of the message.

This assignment email message 500 also includes a message 506 from the coordinator that was extracted from the first section 302 of the message 300 received from the coordinator. This message provides the participant with some context about the assignment. The message 500 also includes instructions 508 that indicate how the co-author can provide the requested information. For example, the message 500 shown in FIG. 5 indicates that the user can fill out the template sections in the message or go to the wiki page 400 and directly enter the requested information. The message 500 indicates the actual assignment defined by the coordinator (e.g., section 304 of the email message 300 in FIG. 3). For example, the message 500 includes a content field 510, due date/time field 512, and instructions field 514. As discussed above, the content field 510 is where the co-author enters the information (content) associated with their designated section. If the coordinator included part of this information, the email message includes this information. For example, the message 500 includes “Project 1”, which was provided by the coordinator. The due date/time field 512 indicates when the content to be provided by the co-author is to be submitted to the collaboration environment 111. The instructions field 512 comprises the instructions given by the coordinator to the co-author for providing the requested information.

Once the notification email message has been created, the collaboration environment 111 sends the email message to the given user via the messaging client 112 and the messaging server 104. Once the user receives the notification message, the user can accept the co-authoring task, reject the task, or transfer the task to one or more others. The user can respond to the notification email message either by replying to the email or selecting the link to the wiki page 400 that is included within the message and entering a response and/or requested information directly into the wiki page 400.

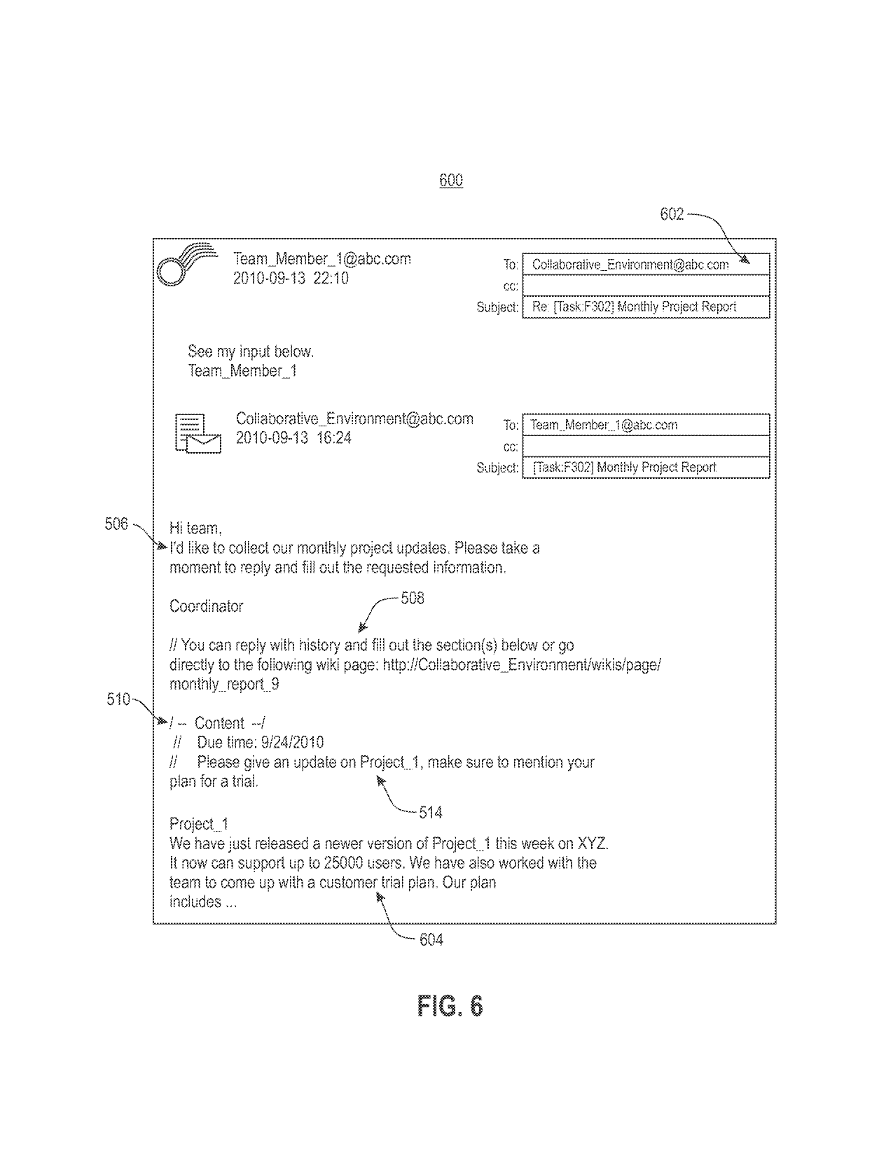

If a participant decides to accept the task, the participant can simply include the requested content in a reply email message that is sent to the collaboration environment 111. For example, FIG. 6 shows an exemplary email message 600 created by a co-author in response to the notification message received from the collaboration environment 111. In this embodiment, a reply template is attached to or embedded within each notification email (or reminder email) sent to a participant.

The email message 600 is addressed to the collaboration environment 111 using the ID (e.g., email address) 602 associated with the collaboration environment 111. The reply email message 600 can include any information including template portions from the notification message received from the collaboration environment 111. For example, FIG. 6 shows that the email message 506 from the coordinator, instructions 508 and 514, and content field 510 have been included in the reply message. However, information from the notification message is not required to be included in a reply message. The reply email message also includes the content 604 created/authored by the co-author that was requested by the coordinator.

Once the co-author has finished creating the reply email message 600, the reply email message 600 is sent to the collaboration environment 111. The collaboration environment 111 receives the reply email message 600 and the message processor 120 analyzes the message and identifies the content created/authored by the user based on the template fields. In addition, the messaging manager 116 is able to identify which collaboration project and wiki page is associated with the message based on the content of the message, an ID associated with the message, the participants identified in the message, etc.

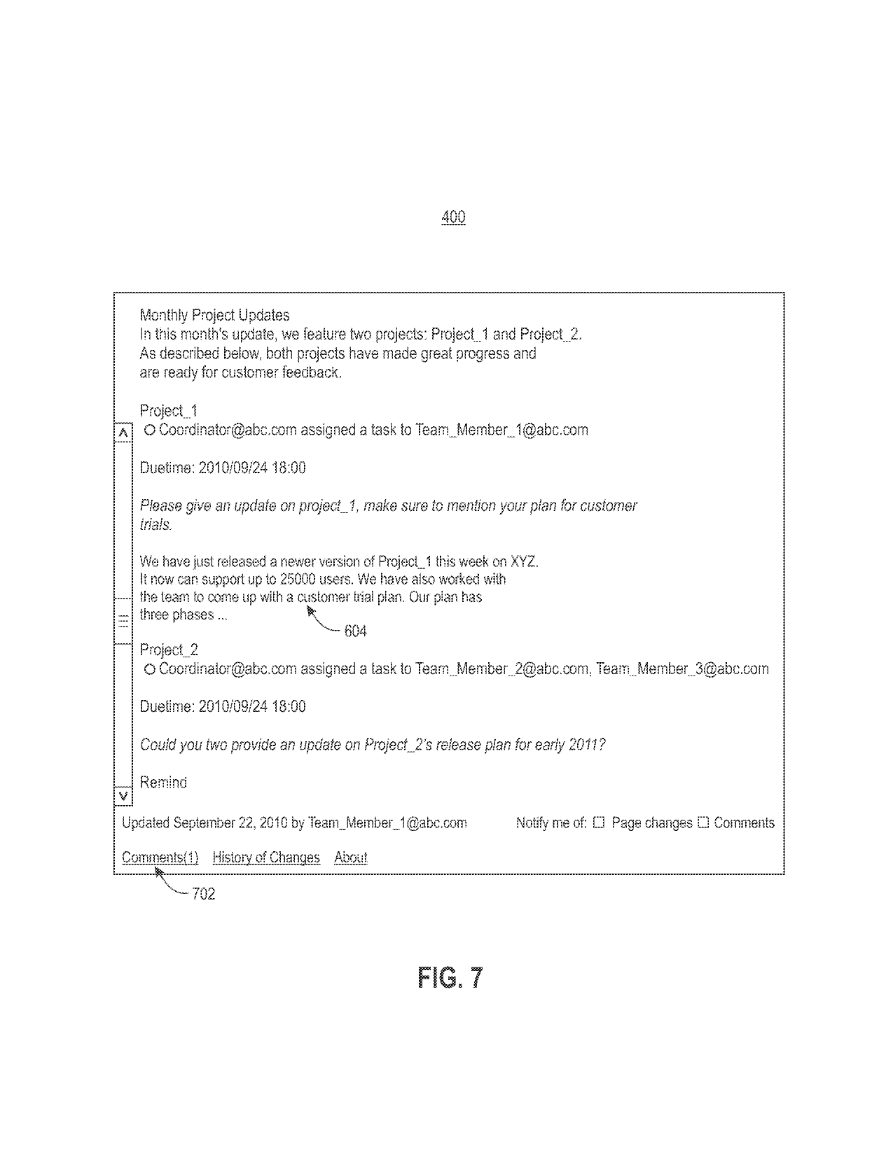

The collaboration environment manager 112 uses the extracted information/content to update the corresponding section in the wiki page 400. For example, FIG. 7 shows that the wiki page 400 has been updated to include the content 604 created/authored by Team_Member_{—}1. In this embodiment, the collaboration environment 111 does not maintain the format of the information within an email when adding the information to the wiki page 400. However, in other embodiments metadata and formatting are maintained. To associate the submitted input (e.g., Team_Member_{—}1's write up for “Project 1” in FIG. 6) with the corresponding section (e.g., the “Project 1” section in FIG. 4), the collaboration environment 111 can use a unique ID to index each participant's emails and the corresponding wild section(s). If the participant rejects the task or delegates it to others, the collaboration environment 111 can forward such responses to the coordinator. Alternatively, the collaboration environment 111 can automatically perform one or more pre-defined actions.

In some instances a participant may intentionally or unintentionally alter the elements of an email template. Therefore, a participant's email response may not be as expected. For example, a participant who is submitting a write-up in a reply email message to the collaboration environment 111 may accidently delete the delimiter that indicates where the participant should enter his write up. As a result, the collaboration environment 111 may not be able to properly parse the participant's reply due to the missing delimiter.

Therefore, in this embodiment, the collaboration environment 111 notifies the coordinator via a message if the response is not in an expected format, and allows the coordinator to process the response. In this embodiment, the collaboration environment 111 forwards the questionable email message to the coordinator with an attached rationale (e.g., cannot extract a co-author's input from the email reply). Instead of changing the messaging template, users may sometimes provide unexpected input in the email message. For example, as shown in FIG. 6, participant Team_Member_{—}1 not only provided his write up on “Project 1” as instructed, but he also gives additional input at the top of the email message (e.g., the “See my input below” text). In one embodiment, any additional input within an email message is not discarded by the collaboration environment 111. Instead, the collaboration environment 111 extracts the unexpected input and uses it to update the “comment” section 702 of the actual write-up in the wiki 400, as shown in FIG. 7.

In another example, a participant may choose to completely ignore the email instructions and simply enter all comments and write-up in one place (e.g., at the top of the email message). In such situations, the collaboration environment 111 does not find the expected content where it should be (e.g., below the delimiter /-- Content --/ in FIG. 6). In this example, the collaboration environment 111 puts all user input in the designated section in the wiki 400 but also informs the coordinator of the out-of-place input to indicate that further action may be necessary.

Sometimes a participant may not be satisfied with the participant's previously submitted write-up. Therefore, the participant may send another reply email message to the collaboration environment 111 with a modified write up. The collaboration environment 111 can handle this situation in various ways. For example, the modified write up can be used to replace the existing one or can be simply appended to the existing one. If there are multiple users who are assigned to work on the same section, the collaboration environment 111 can append one's input to another user's. This provides the coordinator multiple points of view and the decision on which one to keep.

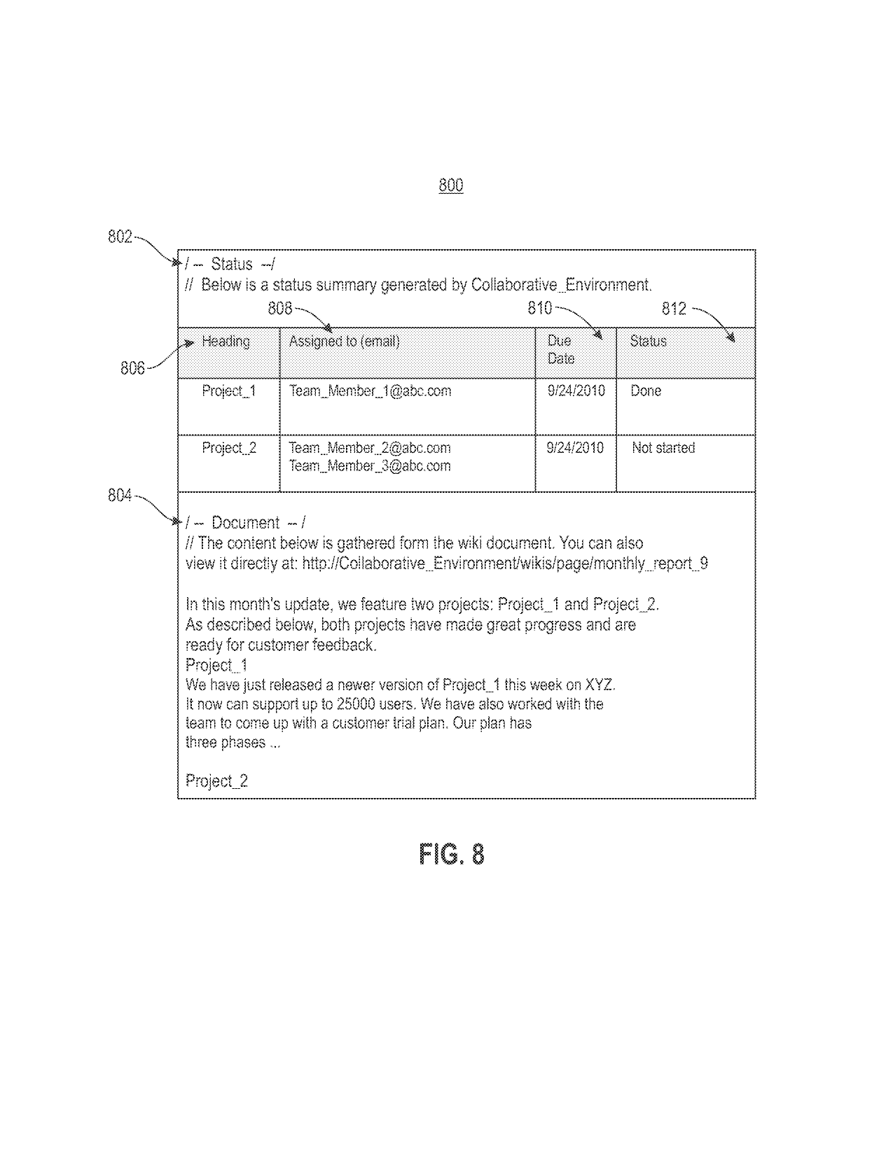

The collaboration environment 111 can also automatically send a status report to users whenever appropriate. For example, in this embodiment the collaboration environment 111 automatically sends a status report to the coordinator, when sending a reminder to the designated participants, as shown in FIG. 8. As can be seen in FIG. 8, the status report 800 includes a status field 802 and a document field 804. The status field 802 includes status information associated with a collaboration projection. This status information can include content heading information 806, designated co-author information 808, due date/time information 810, and status information 812 (e.g., completed, not started, in progress, etc.). The document field 804 can include any content that has been gathered from the associated wiki 400. Users can explicitly request a status report from the collaboration environment 111 as well.

Accordingly, the collaboration environment is a wiki-based tool that supports coordinated, collaborative authoring. Users are able to accomplish their tasks through a messaging mechanism, such as email, in a coordinated, co-authoring process. Users can use messaging templates to specify their requests in email or simply fulfill their co-authoring tasks via email reply. Additionally, the collaboration environment can understand template-based messages from users. The collaboration environment uses the information extracted from these messages to drive the collaboration flow, including automated generation and update of a wiki page to persist and share co-authoring results. As a result, the collaboration environment of the present invention allows users to use their most familiar tool (e.g., email) to complete their tasks in a co-authoring process, while using a wiki as a back channel to provide collaboration awareness.

### Operational Flow Diagrams

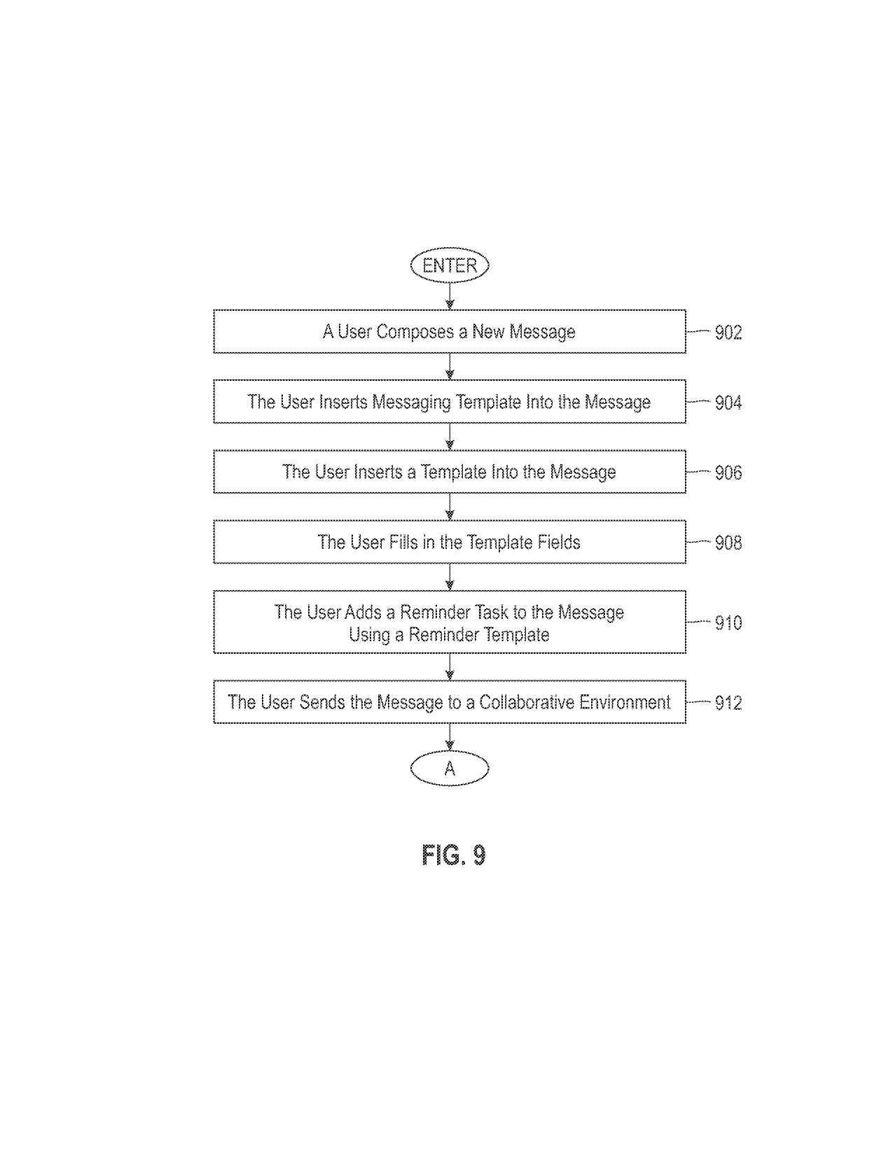

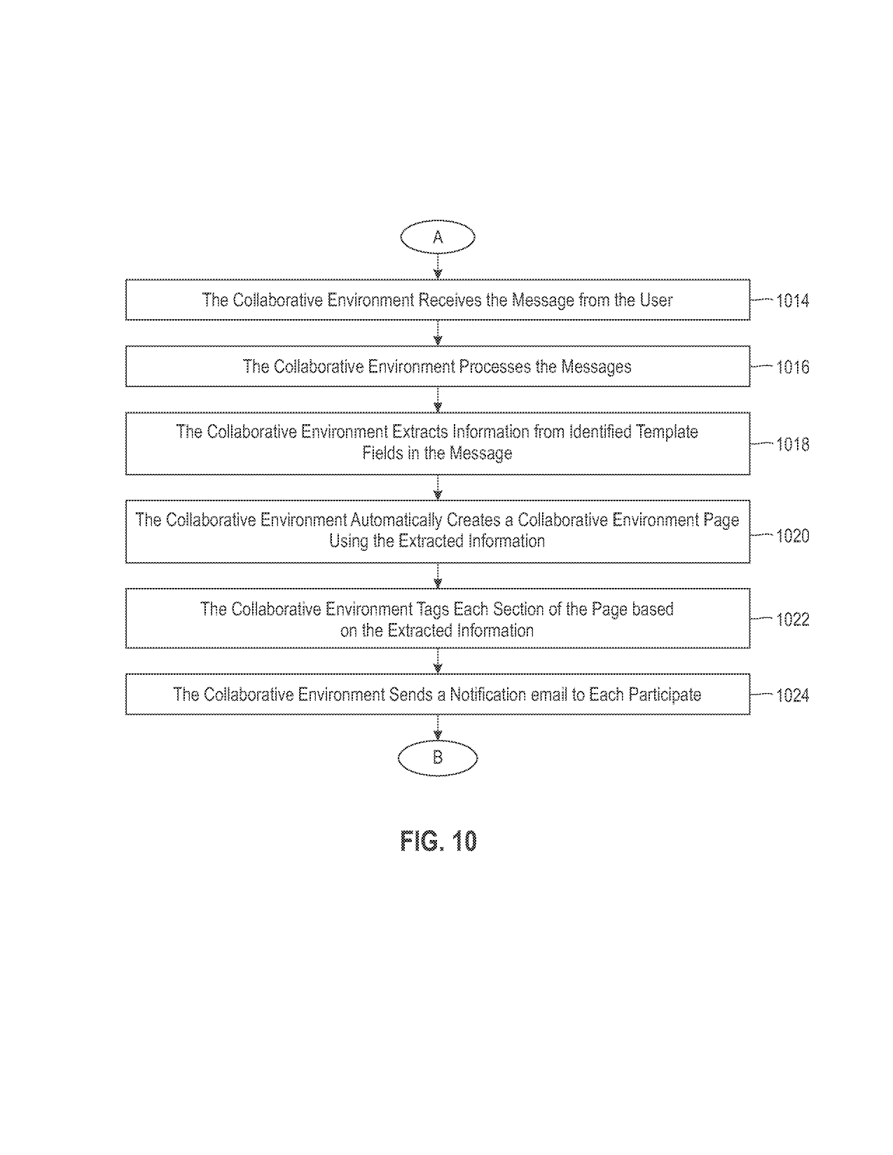

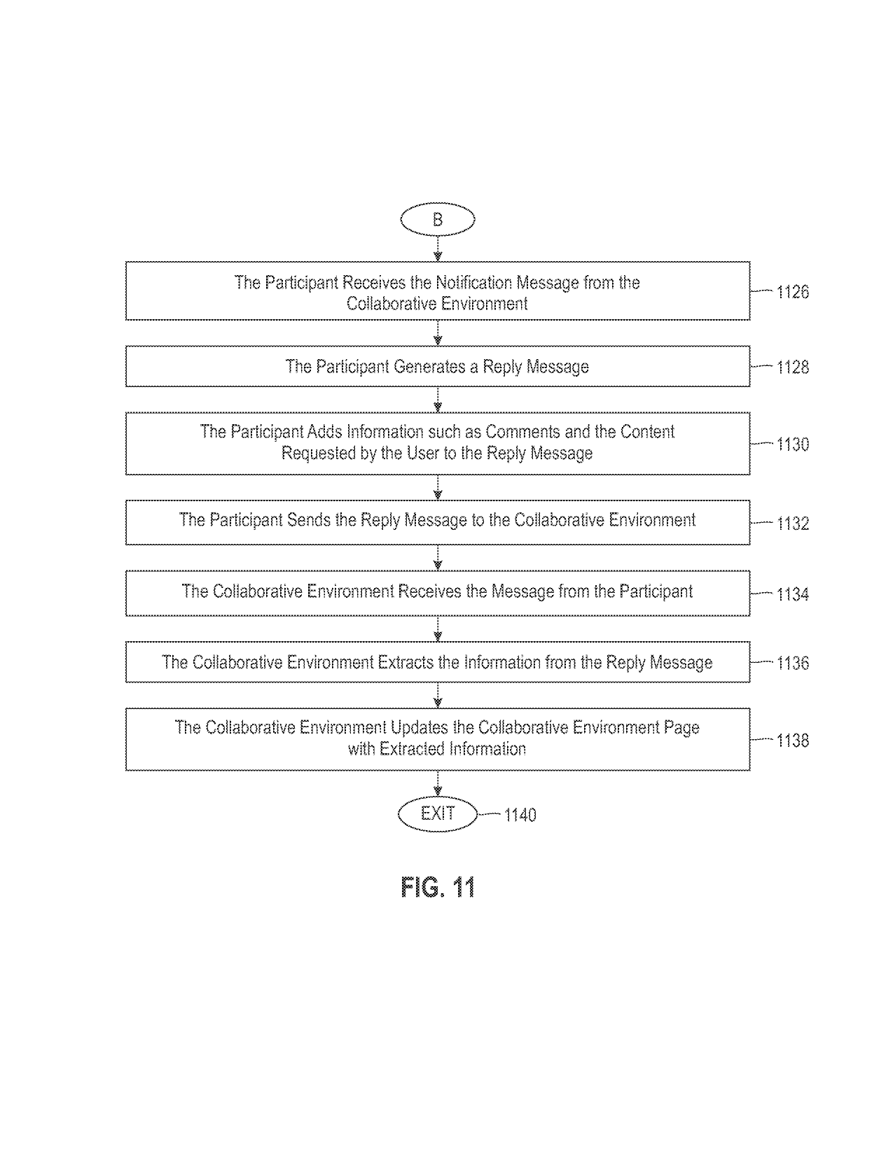

Referring now to FIGS. 9-11, the flowchart(s) and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

FIGS. 9-11 are operational flow diagrams illustrating a process for facilitating coordinated and collaborative authoring using messaging according to one embodiment of the present invention. In this process, any step performed by a user or participant is performed with the user systems 106 and 108. At step 902, a user begins to compose a new message, via a messaging client 124, by using a messaging template provided by the collaborative environment 111. The user inserts a message template for entering a customized, general message to the user's co-authors, at step 904. The user utilizes a template, such as a task or messaging template, to define a set of co-authoring tasks, at step 906. In this template, the user specifies the content to be authored (e.g., preceded by delimiter /-- Content --/) and the designated co-author (e.g., preceded by /-- Author --/). The user can also include input. The user specifies a co-author's email address, due time, and any special instructions to the co-author, at step 908. The user can also use a reminder template to set up a reminder to ensure that the co-authors submit their input on time, at step 910.

After filling in the template, the user emails the message to the collaborative environment 111, at step 912. The collaborative environment 111 receives the email message from the user, at step 1014. Upon receiving the email message, the collaborative environment 111 processes the message and acts upon it, at step 1016. The collaborative environment 111 extracts information from the identified template fields within the message, at step 1018. The collaborative environment 111 uses the information extracted from the email message to automatically create a collaborative environment wiki page 114, at step 1020. The generated wiki page includes the user's authored content and the skeleton of the sections to be authored by the participants designated by the user, respectively. The collaborative environment 111 tags each section of the page with various meta-information, including its author, due time, the user's (coordinator) instruction, and the task status, at step 1022. This provides desired collaboration awareness. After creating the wiki page, the collaborative environment 111 sends a notification email to each of the participants (co-authors), at step 1024.

A participant receives the notification email from the collaborative environment 111, at step 1126. The participant generates a reply message, at step 1128. The participant adds information such as comments and the content requested by the user, at step 1130. The participant then sends the message to the collaborative environment 111, at step 1132. The collaborative environment 111 receives the email message from the participant, at step 1134. The collaborative environment 111 extracts the information that was added to the email message by the participant, at step 1136. The collaborative environment 111 updates the collaborative environment wiki page 114 with the extracted information, at step 1138. The control flow then exits at step 1140. The above process can include other steps as well. For example, the collaborative environment 111 can determine if any other participant has failed to provide their content by a given date that is set by the user. If so, the collaborative environment 111 can send a reminder email message to the participants who have not provided content. The collaborative environment 111 can also send a status report to the user providing a current status of the collaborative task/project.

### Information Processing System

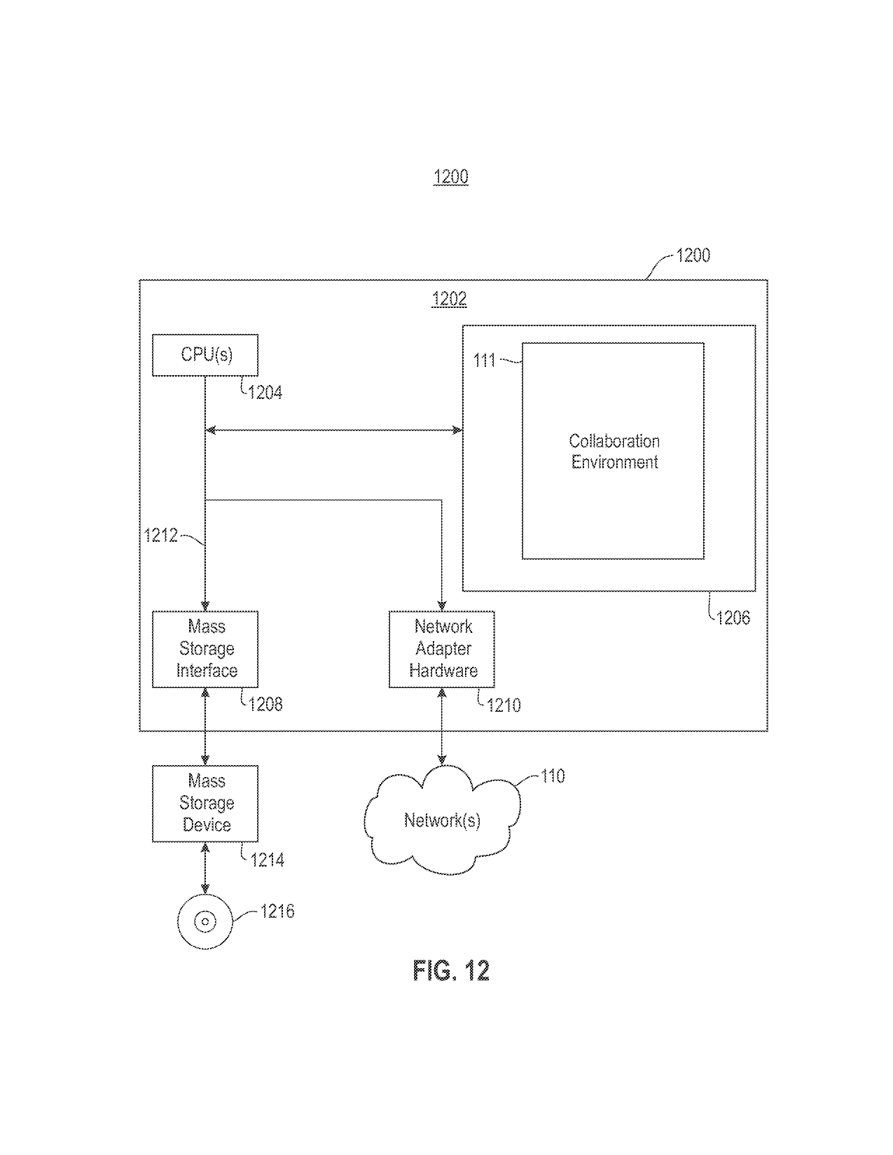

FIG. 12 is a block diagram illustrating an information processing system that can be utilized in embodiments of the present invention. The information processing system 1200 is based upon a suitably configured processing system adapted to implement one or more embodiments of the present invention (e.g., the collaborative environment server 102 of FIG. 1). Any suitably configured processing system can be used as the information processing system in embodiments of the present invention.

The information processing system 1200 includes a computer 1202. The computer 1202 has a processor(s) 1204 that is connected to a main memory 1206, mass storage interface 1208, and network adapter hardware 1210. A system bus 1212 interconnects these system components. Although only one CPU 1204 is illustrated for computer 1202, computer systems with multiple CPUs can be used equally effectively. The main memory 1206, in this embodiment, includes the collaboration environment 111 and its components.

The mass storage interface 1208 is used to connect mass storage devices, such as mass storage device 1214, to the information processing system 1200. One specific type of data storage device is an optical drive such as a CD/DVD drive, which can be used to store data to and read data from a computer readable medium or storage product such as (but not limited to) a CD/DVD 1216. Another type of data storage device is a data storage device configured to support, for example, NTFS type file system operations.

An operating system included in the main memory is a suitable multitasking operating system such as any of the Linux, UNIX, Windows, and Windows Server based operating systems. Embodiments of the present invention are also able to use any other suitable operating system. Some embodiments of the present invention utilize architectures, such as an object oriented framework mechanism, that allows instructions of the components of operating system to be executed on any processor located within the information processing system 1200. The network adapter hardware 1210 is used to provide an interface to a network 110. Embodiments of the present invention are able to be adapted to work with any data communications connections including present day analog and/or digital techniques or via a future networking mechanism.

### Non-Limiting Examples

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been discussed above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments above were chosen and described in order to best explain the principles of the invention and the practical application, and to enable others of ordinary skill in the art to understand the invention for various embodiments with various modifications as are suited to the particular use contemplated.

What is claimed is:

1. A method comprising:
receiving, from a user, a first message associated with a collaborative task, the first message including an identification of the collaborative task, a plurality of participants for the collaborative task, and a request from the user for each of the participants to provide content for the collaborative task;
in response to receiving the first message, generating a request message for each of the participants, each of the request messages including a notification of the collaborative task and the request from the user for that participant to provide the content for the collaborative task; and
sending the request messages to the participants.

2. The method of claim 1, further comprising:
in response to receiving the first message, extracting information from the first message; and
creating a collaborative environment page for the collaborative task based on the information that has been extracted, the collaborative environment page including a separate section for the content to be provided by each of the participants.

3. The method of claim 2, further comprising:
after sending the request messages, receiving a content message from at least one of the participants;
extracting the content from the content message; and
updating the collaborative environment page with the content that has been extracted.

4. The method of claim 2, further comprising:
after sending the request messages, receiving a content message from at least one of the participants;
analyzing the content message to determine whether the one participant has accepted, declined, or transferred the request from the user; and
in response to the analyzing, sending a message to the user to notify the user that the one participant has accepted, declined, or transferred the request from the user.

5. The method of claim 1, wherein generating the request message comprises:
identifying a plurality of template fields within the first message, a first of the template fields comprising first information identifying the participants, and a second of the template fields comprising second information identifying the content to be provided by each of the participants; and
extracting the first information and the second information from the first and second template fields,
wherein the first information and the second information are included in the second messages that are generated.

6. The method of claim 1, further comprising:
determining that the first message comprises at least one reminder task that indicates a condition for sending a reminder to at least one of the participants;
in response to the condition being satisfied with respect to the at least one participant, sending a second message to the at least one participant, the second message comprising a reminder for the at least one participant to provide the content.

7. The method of claim 1, wherein the first message and the request message are email messages.

8. An information processing system comprising:
a memory;
a processor communicatively coupled to the memory; and
messaging manager communicatively coupled to the memory and the processor, wherein the messaging manager is configured to perform a method comprising:
receiving, from a user, a first message associated with a collaborative task, the first message including an identification of the collaborative task, a plurality of participants for the collaborative task, and a request from the user for each of the participants to provide content for the collaborative task;
in response to receiving the first message, generating a request message for each of the participants, each of the request messages including a notification of the collaborative task and the request from the user for that participant to provide the content for the collaborative task; and
sending the request messages to the participants.

9. The information processing system of claim 8, wherein the method further comprises:
in response to receiving the first message, extracting information from the first message; and
creating a collaborative environment page for the collaborative task based on the information that has been extracted, the collaborative environment page including a separate section for the content to be provided by each of the participants.

10. The information processing system of claim 9, wherein the method further comprises:
after sending the request messages, receiving a content message from at least one of the participants;
extracting the content from the content message; and
updating the collaborative environment page with the content that has been extracted.

11. The information processing system of claim 9, wherein the method further comprises:
after sending the request messages, receiving a content message from at least one of the participants;
analyzing the content message to determine whether the one participant has accepted, declined, or transferred the request from the user; and
in response to the analyzing, sending a message to the user to notify the user that the one participant has accepted, declined, or transferred the request from the user.

12. The information processing system of claim 8, wherein generating the request message comprises:
identifying a plurality of template fields within the first message, a first of the template fields comprising first information identifying the participants, and a second of the template fields comprising second information identifying the content to be provided by each of the participants; and
extracting the first information and the second information from the first and second template fields,
wherein the first information and the second information are included in the second messages that are generated.

13. The information processing system of claim 9, wherein the first message and the request message are email messages.

14. A computer program product comprising:
a non-transitory computer readable storage medium having computer readable program code embodied therewith, the computer readable program code configured to perform a method comprising:
receiving, from a user, a first message associated with a collaborative task, the first message including an identification of the collaborative task, a plurality of participants for the collaborative task, and a request from the user for each of the participants to provide content for the collaborative task;
in response to receiving the first message, generating a request message for each of the participants, each of the request messages including a notification of the collaborative task and the request from the user for that participant to provide the content for the collaborative task; and
sending the request messages to the participants.

15. The computer program product of claim 14, wherein the method further comprises:
in response to receiving the first message, extracting information from the first message; and
creating a collaborative environment page for the collaborative task based on the information that has been extracted, the collaborative environment page including a separate section for the content to be provided by each of the participants.

16. The computer program product of claim 15, wherein the method further comprises:
after sending the request messages, receiving a content message from at least one of the participants;
extracting the content from the content message; and
updating the collaborative environment page with the content that has been extracted.

17. The computer program product of claim 15, wherein the method further comprises:
after sending the request messages, receiving a content message from at least one of the participants;
analyzing the content message to determine whether the one participant has accepted, declined, or transferred the request from the user; and
in response to the analyzing, sending a message to the user to notify the user that the one participant has accepted, declined, or transferred the request from the user.

18. The computer program product of claim 14, wherein generating the request message comprises:
identifying a plurality of template fields within the first message, a first of the template fields comprising first information identifying the participants, and a second of the template fields comprising second information identifying the content to be provided by each of the participants; and
extracting the first information and the second information from the first and second template fields,
wherein the first information and the second information are included in the second messages that are generated.

19. The computer program product of claim 14, wherein the method further comprises:
determining that the first message comprises at least one reminder task that indicates a condition for sending a reminder to at least one of the participants;
in response to the condition being satisfied with respect to the at least one participant, sending a second message to the at least one participant, the second message comprising a reminder for the at least one participant to provide the content.

20. The computer program product of claim 14, wherein the first message and the request message are email messages.
